(19) United States
(12) Patent Application Publication
(10) Pub. No.: US 2010/0263842 A1
(43) Pub. Date: Oct. 21, 2010

(54) HEAT EXCHANGER WITH SURFACE-TREATED SUBSTRATE

(75) Inventors: Gabor Ast, Garching bei Muenchen (DE); Sebastian Walter Freund, Unterfohring bei Muenchen (DE); Thomas Johannes Frey, Ingolstadt (DE); Matthew Alexander Lehar, Muenchen (DE); Richard Aumann, Muenchen (DE)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/425,424

(22) Filed: Apr. 17, 2009

(51) Int. Cl. F28F 19/00; F01K 23/00; B32B 3/10; B05D 3/12; B05D 3/10; B44C 1/22

(52) U.S. Cl. 165/133; 60/670; 428/143; 427/307; 216/37

(57) ABSTRACT

An organic rankine cycle system for recovering and utilizing waste heat from a waste heat source by using a closed circuit of a working fluid is provided. The organic rankine cycle system includes at least one evaporator. The evaporator further includes a surface-treated substrate for promoting nucleate boiling of the working fluid thereby limiting the temperature of the working fluid below a predetermined temperature. The evaporator is further configured to vaporize the working fluid by utilizing the waste heat from the waste heat source.

### BACKGROUND

The invention relates generally to a heat exchanger in an organic rankine cycle and more particularly to a heat exchanger with a surface-treated substrate for improved heat exchange efficiency.

Most organic Rankine cycle systems (ORC) are deployed as retrofits for small- and medium-scale gas turbines, to capture an additional power on top of an engine's baseline output from a stream of hot flue gases of the gas turbines. A working fluid used in these cycles is typically a hydrocarbon with a boiling temperature slightly above the defined temperature by International Organization for Standardization (ISO) at atmospheric pressure. Because of the concern that such hydrocarbon fluids may degrade if exposed directly to a high-temperature (˜500° C.) gas turbine exhaust stream, an intermediate thermal oil circuit system is generally used to convey heat from the exhaust to the Rankine cycle boiler. The thermal oil circuit system causes additional investment cost which can represent up to one-quarter of the cost of the complete cycle. Moreover, incorporating the thermal oil circuit system causes a significant drop of utilizable temperature level of the heat source. Furthermore, the intermediate fluid system and heat exchangers require a higher temperature difference resulting in increase in size and lowering of overall efficiency.

Therefore, an improved ORC system is desirable to address one or more of the aforementioned issues.

### BRIEF DESCRIPTION

In accordance with an embodiment of the invention, an organic rankine cycle system for recovering and utilizing waste heat from a waste heat source by using a closed circuit of a working fluid is provided. The organic rankine cycle system includes at least one evaporator. The evaporator further includes a surface-treated substrate for promoting nucleate boiling of the working fluid thereby limiting the temperature of the working fluid below a predetermined temperature. The evaporator is further configured to vaporize the working fluid by utilizing the waste heat from the waste heat source.

In accordance with another embodiment of the invention, a surface-treated substrate for promoting nucleate boiling of a working fluid thereby limiting a temperature of the working fluid below a predetermined temperature in a heat exchanger is provided. The surface-treated substrate includes multiple particles or fibers for promoting the formation of bubbles in the working fluid and suspended in a matrix. The surface-treated substrate further includes a thermally conductive binder for binding the plurality of particles or fibers.

In accordance with yet another embodiment of the invention, a method of treating a boiling surface of a heat exchanger for promoting nucleate boiling of a working fluid flow through the heat exchanger, thereby limiting the temperature of the working fluid below a predetermined temperature is provided. The method includes preparing the surface of the heat exchanger for one or more non-uniformities. The method also includes depositing a coating layer on the surface of the heat exchanger.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of an organic Rankine cycle system having a direct evaporator.

FIG. 2 is a perspective view of a heat exchanger tube with portions of the tube being broken away illustrating a surface-treated substrate in accordance with an exemplary embodiment of the invention.

FIG. 3 depicts a schematic block diagram for generating a treated-surface on a boiling side of a heat exchanger tube.

### DETAILED DESCRIPTION

The present techniques are generally directed to an organic rankine cycle system for recovering and utilizing waste heat from a waste heat source by using a closed circuit of a working fluid. In particular, embodiments of the organic rankine cycle system includes a heat exchanger with a surface-treated substrate for promoting nucleate boiling of a working fluid thereby limiting a temperature of the working fluid below a predetermined temperature. The present technique is also directed to a method of treating a boiling surface of a heat exchanger for promoting nucleate boiling of a working fluid flow through the heat exchanger.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

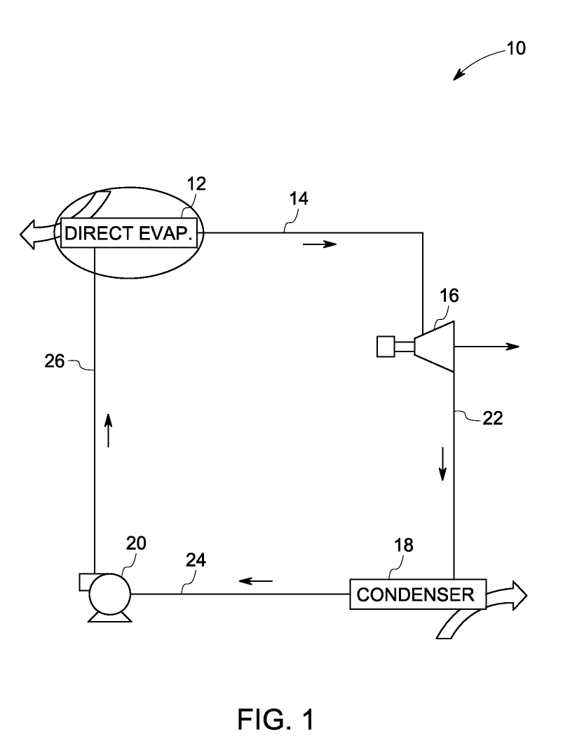

FIG. 1 is a schematic flow diagram of an exemplary embodiment of an organic rankine cycle system 10 for recovering and utilizing waste heat from a waste heat source by using a closed circuit of a working fluid 14. The system 10 uses an organic, high molecular mass working fluid 14, wherein the working fluid allows heat recovery from temperature sources including exhaust flue gas streams from gas turbines. In one embodiment, the system 10 may include heat recovery from lower temperature sources such as industrial waste heat, geothermal heat, solar ponds, etc. The system 10 further converts the low temperature heat to useful work that may be still further converted into electricity. This is accomplished by the use of at least one turbine 16 for expanding the working fluid 14 so as to produce shaft power and an expanded working fluid 22. The turbine 16 may include a two-stage radial turbine for expanding the working fluid 14. During the expansion of the working fluid 14, a significant part of heat energy recoverable from the direct evaporator 12 is transformed into useful work. The expansion of the working fluid 14 in the turbine 16 results in decrease in temperature and pressure of the working fluid 14.

Further, the expanded working fluid 22 enters a condenser 18 for condensing via a cooling fluid flowing through the condenser 18 so as to produce a condensed working fluid 24 at a further lower pressure. In one embodiment, the condensation of the expanded working fluid 22 may be carried out via flow of air at ambient temperature. The flow of air at ambient temperature may be carried out using a fan or blower resulting in a drop of temperature, which may be approximately 40 degree centigrade drop. In another embodiment, the condenser 18 may use cooling water as a cooling fluid. The condenser 18 may include a typical heat exchanger section having multiple tube passes for the expanded working fluid 22 to pass through. In one embodiment, a motorized fan is used to blow ambient air through the heat exchange section. In such a process, the latent heat of the expanded working fluid 22 is given up and is transferred to the cooling fluid used in the condenser 18. The expanded working fluid 22 is thereby condensed to the condensed working fluid 24, which is in a liquid phase at a further lower temperature and pressure.

The condensed working fluid 24 is further pumped from the lower pressure to a higher pressure by a pump 20. The pressurized working fluid 26 may then enter a direct evaporator or boiler 12 and pass through multiple tubes in fluid communication with the closed circuit of the working fluid 14 as illustrated in FIG. 1. The direct evaporator 12 may include passages for exhaust gases from the waste heat source for directly heating the pressurized working fluid 26 passing through multiple tubes in the direct evaporator 12.

The pressurized working fluid 26 entering the direct evaporator 12 may include a hydrocarbon with a low boiling point temperature. The thermodynamic characteristics such as a high temperature stability of the working fluid 14 in the direct evaporator 12 of the organic Rankine cycle system 10 may be difficult to maintain because the temperature of the working fluid 14 may be exposed to a breakdown threshold temperature at a heat exchanger surface in the tubes of the direct evaporator 12, resulting in thermal decomposition of the working fluid 14. In one embodiment, the direct evaporator 12 or the condenser 18 of the system 10 may be a typical heat exchanger used in a heat engine cycle.

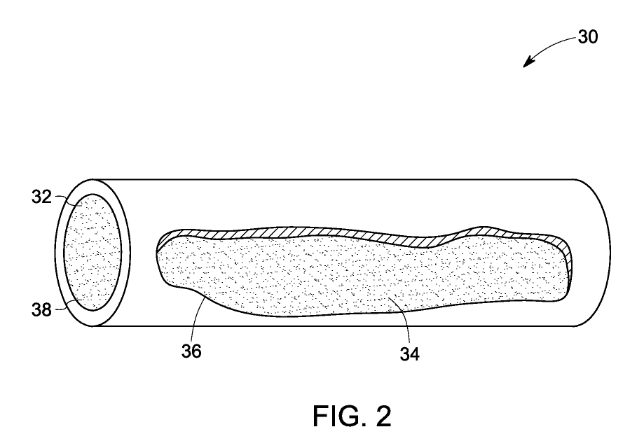

FIG. 2 shows a perspective view of a direct evaporator tube 30 with portions of the tube being broken away illustrating a surface-treated substrate 32 in accordance with an exemplary embodiment of the invention. The direct evaporator 12 of FIG. 1 may include multiple direct evaporator tubes 30. The surface-treated substrate 32 in the direct evaporator tube 30 promotes nucleate boiling of the working fluid thereby limiting the temperature of the working fluid 14 (FIG. 1) below a predetermined temperature. Thus, high temperatures in the boiling surface 38 of the tube walls of the direct evaporator 12 is avoided by the use of the surface-treated substrate 32 for promoting nucleate boiling which further enhances the heat flux of the boiling process in order to reach better cooling of the boiling surface 38 of the direct evaporator tube 30. Thereby, the present technique improves the heat transfer from the heated surface of the direct evaporator to the boiling working fluid 14. The phenomenon of nucleate boiling by the surface-treated surface 32 is discussed in detail below.

In one embodiment, the surface-treated substrate 32 includes a coating 36 disposed on the boiling surface 38 of the direct evaporator tube 30 and used for promoting nucleate boiling of a working fluid thereby limiting a temperature of the working fluid below a predetermined temperature in the direct evaporator 12. In one embodiment, the predetermined temperature of the working fluid 14 may vary from about 200° C. to about 300° C. The surface-treated substrate 32 may include multiple particles or fibres 34 suspended in a matrix. In one embodiment, the surface-treated substrate 32 may also include multiple fibers suspended in the matrix. In operation, the particles or fibers 34 act as seeds for the formation of bubbles when the working fluid is to be evaporated. This causes more locations where vapor bubbles are formed at the same time resulting in a higher heat flux, as it is known that the heat flux to a fluid in which phase change is taking place is up to a magnitude higher than the heat transfer to a fluid by convection. The higher heat flux helps to cool the heat exchanger surface more effectively that results in a lower equilibrium temperature of the heat exchanger surface, as the heat transfer coefficient on the hot side remains almost the same. Moreover, the heat flux increases slightly due to a higher temperature gradient. The metal particles 34 acting as evaporation seeds also help to break the adhesion tension of the bubbles to the heat exchanger surface, so that the vapor bubbles dissolve from the surface while they are still small resulting in further increase of the heat flux on the colder side of the heat exchanger wall. Such evaporation seeds not only promote nucleate boiling, but also enhance the wetting of the surface compared to a smooth surface and thereby tend to suppress the onset of film boiling. The other beneficial effect of promoting the detachment of vapor bubbles from the boiling surface is that it prevents the bubbles from consolidating into a continuous vapor film, which would otherwise greatly reduce convective heat transfer, as heat transfer by convection in a vapor layer is a magnitude lower than that in a liquid film.

On the contrary, in the case of a smooth boiling surface only a few bubble points exist and the initiation of bubble growth requires a large degree of superheat due to the compressive force of liquid surface tension on a very small bubble. The heat for bubble growth must be transferred by convection and conduction from the smooth boiling surface to the distant liquid-vapor interface of a bubble, which is almost completely surrounded by bulk liquid. Thus, it can be said that the non-uniform surface of the heat exchanger wall due to the substrate-treated surface enhances the heat flux on the boiling or evaporation side leading to a lower wall temperatures of the heat exchanger or direct evaporator 12 of FIG. 1, which again results in lower decomposition rates of the ORC working fluid 14.

In one embodiment the size of the particles may vary from 1 micrometer to 100 micrometers. The coating 36 further encourages the separation of the vapor bubbles from the boiling surface 38 thereby increasing the active surface area of the heat transfer and thus further resulting in higher heat flux. The surface-treated substrate 32 also includes a thermally conductive binder for binding the multiple particles or fibers 34. In another embodiment, the thermally conductive binder comprises a high conductive material varying from 1 W·m⁻¹·K⁻¹ to 300 W·m⁻¹ ·K⁻¹. In yet another embodiment, the fibers 34 include fiberglass, quartz, mineral crystals, and metallic compounds. In a still further embodiment, the fibers 34 may include ceramic compounds.

Additionally, in one embodiment, the coating 36 may include a hydrophilic layer, which hydrophilic layer further includes implanted ions. Ion implanting can change the surface energy and thereby influences whether the surface is hydrophilic or hydrophobic. In another embodiment, the multiple ions may include nitrogen-based ions. Nitrogen-based ions are one of the more common classes of ions with which a surface may be impregnated to promote adhesion of a liquid.

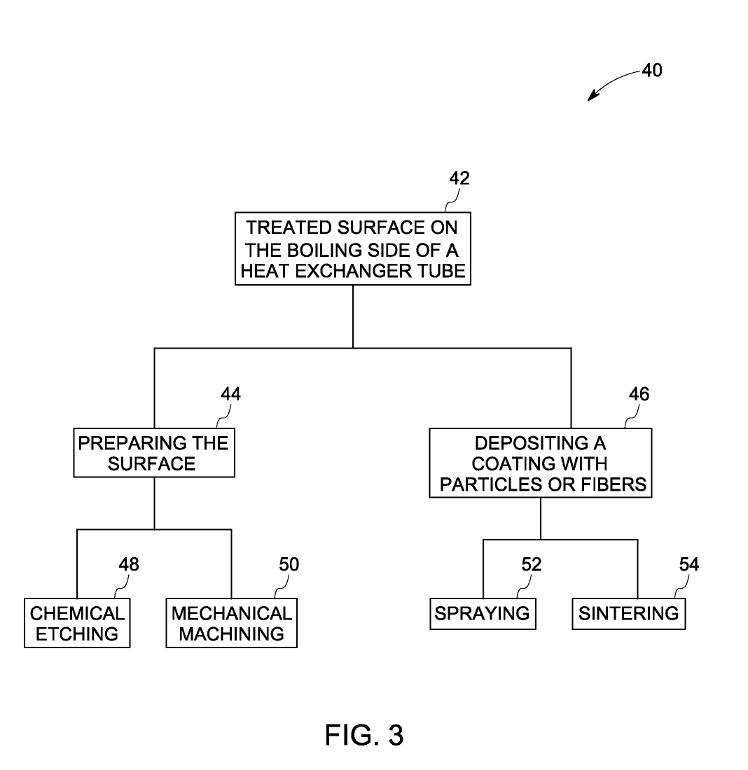

FIG. 3 is a schematic block diagram 40 illustrating various embodiments for preparing a treated-surface 42 on a boiling surface 38 of a direct evaporator tube 30 in FIG. 2. The block diagram 40, primarily illustrates a method of treating the boiling surface 38 of the direct evaporator 12 (FIG. 1) for promoting nucleate boiling of a working fluid flow through the direct evaporator tube 30. In one embodiment as represented by block 44, a method of preparing the surface of the heat exchanger or direct evaporator 12 for one or more non-uniformities is shown. In another embodiment as represented by block 46 is shown a method for depositing a coating 36 as shown in FIG. 2 on the boiling surface 38 of a heat exchanger or direct evaporator tube 30. In a further embodiment, the coating 38 may be laminated on the boiling surface 38 of the direct evaporator tube 30, where the pressurized working fluid is vaporized. In yet another embodiment, preparing the surface of the direct evaporator wall for non-uniformities may include chemical etching as represented in block 48. In a still further embodiment, preparing the surface of the direct evaporator wall for non-uniformities may include mechanical machining as shown in block 50. The mechanical machining includes at least one of the processes of rolling, milling, grinding or turning.

In another embodiment, depositing the coating on the boiling surface 38 of the heat exchanger or direct evaporator tube 30 includes spraying of multiple particles or fibers on the surface of the heat exchanger as shown in block 52 of FIG. 3. In a particular embodiment, the multiple particles 34 as shown in FIG. 2 may include metal particles. In yet another embodiment, depositing the coating on the boiling surface 38 of the heat exchanger or direct evaporator tube 30 includes sintering as illustrated in block 54 of FIG. 3. In a particular embodiment, sintering 54 may include heating the metal particles below its melting point until the metal particles adhere or fuse to each other. In operation, the particles or fibers 34 may act as seeds for nucleate boiling so that more little vapors are formed instead of bigger bubbles. This phenomenon results in increased heat flux over the heat exchanger wall of the direct evaporator 12.

Advantageously, the present invention introduces a surface-treated substrate including a coating or machined surface or a chemically treated surface in a direct evaporator of an organic rankine cycle system for substantial heat transfer efficiency from the boiling or evaporation surface of the heat exchanger to the working fluid 14. Thus, the temperature of the boiling surface of the heat exchanger or direct evaporator 12 remains relatively lower avoiding the decomposition of the working fluid 14. The other advantage of the present invention is the elimination of the intermediate thermo-oil loop system, which makes the present invention less complex and more economical. The investment cost in the ORC system can be lowered by one-quarter of the total investment costs by eliminating the intermediate thermo-oil loop system.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An organic rankine cycle system for recovering and utilizing waste heat from a waste heat source by using a closed circuit of a working fluid, the system comprising:
at least one evaporator comprising a surface-treated substrate for promoting nucleate boiling of the working fluid thereby limiting the temperature of the working fluid below a predetermined temperature, the evaporator further configured to vaporize the working fluid by utilizing the waste heat from the waste heat source.

2. The system of claim 1, further comprising at least one turbine for expanding the working fluid so as to produce shaft power and an expanded working fluid, wherein the working fluid is a hydrocarbon.

3. The system of claim 1, further comprising at least one condenser for condensing the expanded working fluid by an action of a flow of air at ambient temperature so as to produce a condensed working fluid at a low pressure.

4. The system of claim 1, further comprising at least one pump for pumping the condensed working fluid to the evaporator

5. The system of claim 1, wherein the evaporator comprises a plurality of tubes in fluid communication with the closed circuit of the working fluid and further comprises a passage for exhaust gases from the waste heat source for directly heating the working fluid passing through the evaporator.

6. The system of claim 1, wherein the surface-treated substrate comprises a coating laminated on boiling side of the evaporator surface.

7. The system of claim 6, wherein the coating comprises particles or fibers for the formation of bubbles of the working fluid in the evaporator.

8. The system of claim 1, wherein the surface-treated substrate further comprises a non-uniform surface for the formation of bubbles of the working fluid in the evaporator.

9. A surface-treated substrate for promoting nucleate boiling of a working fluid thereby limiting a temperature of the working fluid below a predetermined temperature in a heat exchanger, the surface-treated substrate comprising:
a plurality of particles or fibres for promoting the formation of bubbles in the working fluid and suspended in a matrix, and
a thermally conductive binder for binding the plurality of particles or fibres.

10. The surface-treated substrate of claim 9, wherein the size of the particles varies from about 1 μm to about 100 μm.

11. The surface-treated substrate of claim 9, wherein the predetermined temperature of the working fluid varies from about 200° C. to about 300° C.

12. The surface-treated substrate of claim 9, wherein the thermally conductive binder comprises a high conductive material varying from about 1 W·m⁻¹·K⁻¹ to about 300 W·m⁻¹·K⁻¹.

13. The surface-treated substrate of claim 9, wherein the fibres comprise of fiberglass, quartz, mineral crystals, metallic or ceramic compounds.

14. The surface-treated substrate of claim 9, wherein the heat exchanger comprises at least one of an evaporator or a condenser.

15. The surface-treated substrate of claim 9, further comprises a coating disposed on the boiling side of the evaporator, wherein the coating further comprises a hydrophilic layer, which hydrophilic layer further comprises a plurality of nitrogen based ions.

16. A method of treating a boiling surface of a heat exchanger for promoting nucleate boiling of a working fluid flow through the heat exchanger, thereby limiting the temperature of the working fluid below a predetermined temperature, the method comprising:
preparing the surface of the heat exchanger for one or more non-uniformities; and
depositing a coating layer on the surface of the heat exchanger.

17. The method of claim 16, wherein said preparing the surface of the heat exchanger comprises chemical etching.

18. The method of claim 16, wherein said preparing the surface of the heat exchanger comprises mechanical machining.

19. The method of claim 16, wherein the mechanical machining process comprises at least one of rolling, milling, grinding or turning.

20. The method of claim 16, wherein said depositing the coating layer comprises spraying of metal particles on the boiling surface of the heat exchanger.

21. The method of claim 16, wherein said depositing the coating layer comprises sintering.
